(19) United States
(12) Patent Application Publication
(10) Pub. No.: US 2025/0224368 A1
(43) Pub. Date: Jul. 10, 2025

(54) DIFFERENTIAL ELECTROCHEMICAL MASS SPECTROMETRY FOR ONLINE GAS EVOLUTION OF POUCH CELLS

(71) Applicant: GM GLOBAL TECHNOLOGY OPERATIONS LLC, Detroit, MI (US)

(72) Inventors: Robert Steven CONELL, Sterling Heights, MI (US); William Osad, Macomb, MI (US); Meinan He, Birmingham, MI (US); Jane Edgington, Chicago, IL (US)

(21) Appl. No.: 18/408,921

(22) Filed: Jan. 10, 2024

(51) Int. Cl. G01N 27/416; H01M 10/42; H01M 10/44; H01M 50/30

(52) U.S. Cl. CPC G01N 27/4162; H01M 10/4285; H01M 10/44; H01M 50/30

(57) ABSTRACT

A method for differential electrochemical mass spectrometry for online gas evolution of pouch cells includes supplying an inert carrier gas to a pouch cell, and supplying gas from the pouch cell to the intake of a differential electrochemical mass spectrometer. A system for continuous quantitative gas evolution monitoring in a pouch cell comprising a differential mass spectrometer, a supply of inert carrier gas, a conduit connected to the pouch cell for conducting inert carrier gas to the pouch cell; and a conduit connecting the pouch cell for conducting gas from the pouch cell to the differential mass spectrometer.

### GOVERNMENT FUNDING

This invention was made with Government support under Agreement No. DE-EE0009644 awarded by the U.S. Department of Energy. The Government may have certain rights in the invention.

### INTRODUCTION

This disclosure relates to Differential Electrochemical Mass Spectrometry for online Gas Evolution of Pouch Cells

### BACKGROUND

The design of battery cells often involves the use of Differential Electrochemical Mass Spectrometry to measure online gas evolution of the cell during electrochemical cycling. However, adapting Differential Electrochemical Mass Spectrometry for use in pouch-type cells has been difficult. The fluid electrolyte and limited amount of active material in such cells can make it challenging to quantify the gas generation.

### SUMMARY

Embodiments of this disclosure provide for Differential Electrochemical Mass Spectrometry for online Gas Evolution of Pouch Cells. According to a first embodiment, a method for differential electrochemical mass spectrometry for online gas evolution of pouch cells is provided. Generally, the method comprises supplying an inert carrier gas to a pouch cell; and supplying gas from the pouch cell to the intake of a differential electrochemical mass spectrometer to analyze the gas generated by the pouch cell. The inert carrier gas can be argon, or some other suitable inert carrier gas. In this first embodiment, the inert carrier gas can be provided through a mass flow controller, supplied with a gas tank.

The method of the first embodiment can facilitate the investigation of the operation of a battery cell, allowing measurement of the generation of various gases. To this end the pouch cell can be connected to a battery cycler for cycling the pouch cell through discharge and charging cycles while the gas from the pouch cell is provided to the intake of a differential electrochemical mass spectrometer, to determine the identities and quantities of the gasses generated. Similarly, the pouch cell can be heated while gas from the pouch cell is provided to the intake of a differential electrochemical mass spectrometer, to determine the identities and quantities of the gases generated at different temperatures. Of course, both the battery cycler and heater can be used to determine the operating of the cells under various conditions.

In operation, after establishing inlet and outlet ports in the pouch, and introducing the flow of an inert carrier gas into the inlet port in the pouch, the pouch is purged for a while to eliminate built up reaction products such as N₂, O₂, CO₂, ethylene carbonate, and ethyl methyl carbonate, to achieve stable baselines before beginning experimentation and measurement.

According to a second embodiment of this disclosure, a system for continuous quantitative gas evolution monitoring in a pouch cell is provided. The system can comprise a differential mass spectrometer and a supply of inert carrier gas. The system further comprises a conduit connected to the pouch cell for conducting inert carrier gas to the pouch cell, and a conduit connected to the pouch cell for conducting gas from the pouch cell to the differential mass spectrometer. A mass flow controller can be provided in the first conduit connecting a supply of inert carrier gas, such as a pressurized tank with a regulator, to the pouch cell. The supply of inert carrier case can be a pressurized tank, and a regulator for regulating the outlet pressure from the pressurized tank. There can be a relief outlet between the regulator and the mass flow controller, to vent excess inert carrier gas. There can also be an excess flow bypass in the conduit between the pouch cell and the differential mass spectrometer.

### BRIEF DESCRIPTION OF THE DRAWINGS

The present disclosure will become more fully understood from the detailed description and the accompanying drawings, wherein:

FIG. 1 is a flow chart of a first embodiment of a method for continuous quantitative gas evolution monitoring;

FIG. 2 is a flow chart of an alternate to the first embodiment of a method for continuous quantitative gas evolution monitoring;

FIG. 3 is a perspective view of a pouch cell with which the methods and system of this can be used to investigate the operation of the cell;

FIG. 4 is a schematic diagram of a system for continuous quantitative gas evolution monitoring in a pouch cell according to the principles of this disclosure;

FIG. 5 is a graph of the pressure in torr (vertical axis) versus time in hours (horizontal axis) of the various gassed generated by a 50 D cell with an EC/EMC electrolyte with a 4.2 V cutoff (upper portion) and a graph of the cell voltage in volts (vertical axis) versus time in hours (horizontal axis);

FIG. 6 is a graph of the pressure in torr (vertical axis) versus time in hours (horizontal axis) of the various gassed generated by a 50 D cell with an EC/EMC electrolyte with a 4.5 V cutoff (upper portion) and a graph of the cell voltage in volts (vertical axis) versus time in hours (horizontal axis);

FIG. 7 is a graph of the pressure in torr (vertical axis) versus time in hours (horizontal axis) of the various gassed generated by a 50 D cell with an FEC, DMC electrolyte with a 4.2 V cutoff (upper portion) and a graph of the cell voltage in volts (vertical axis) versus time in hours (horizontal axis);

FIG. 8 is a graph of CO₂ molar production rate in μmol/s (vertical axis) versus time in hours for cells with an EC/EMC electrolyte and a cut off at 4.2V and 4.5V, and for cells with a FEC/DMC electrolyte, and a cutoff at 4.2V and 4.5V; and

FIG. 9 is a graph of cumulative CO₂ molar production rate in μmol/s (vertical axis) versus time in hours for cells with an EC/EMC electrolyte and a cut off at 4.2V and 4.5V, and for cells with a FEC/DMC electrolyte, and a cutoff at 4.2V and 4.5V.

### DETAILED DESCRIPTION

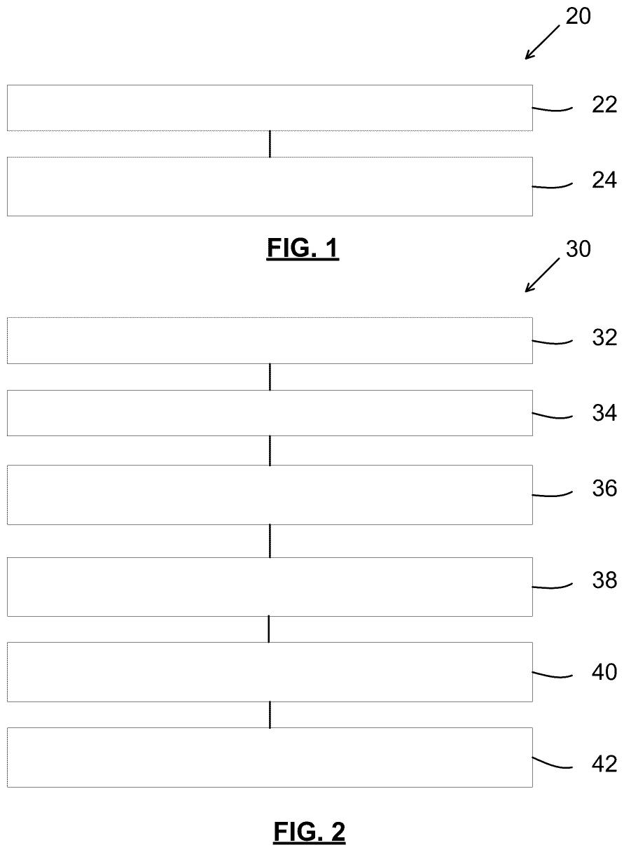

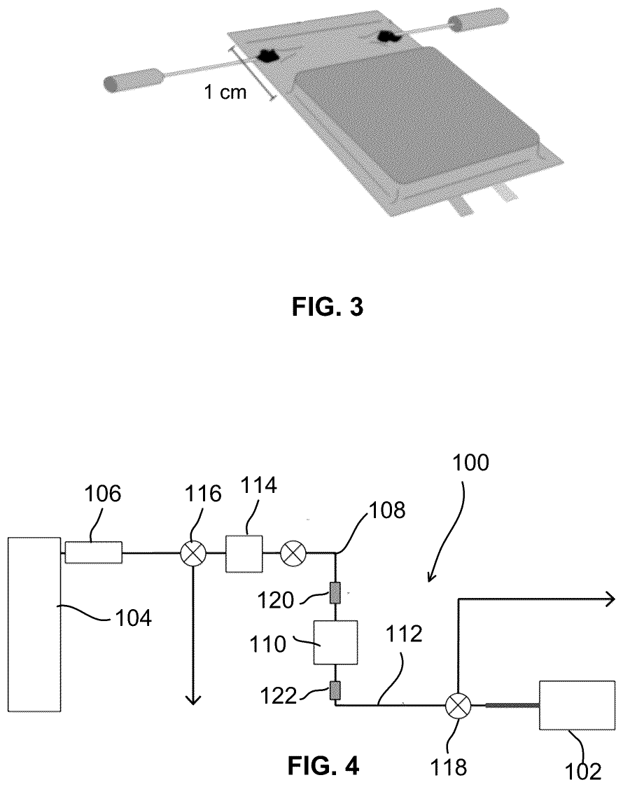

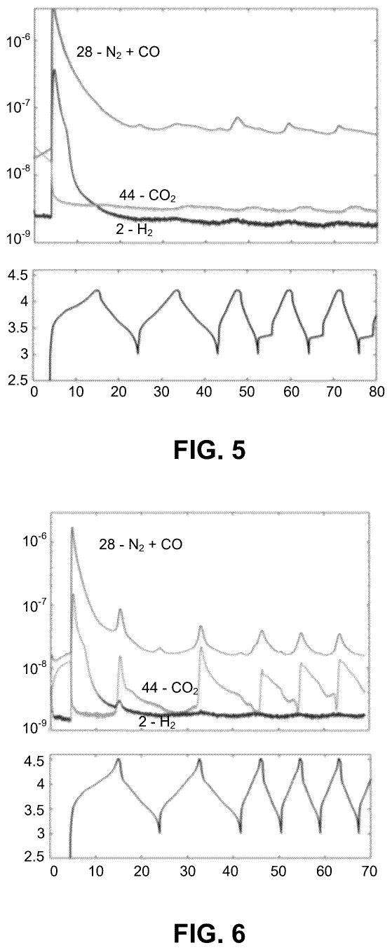

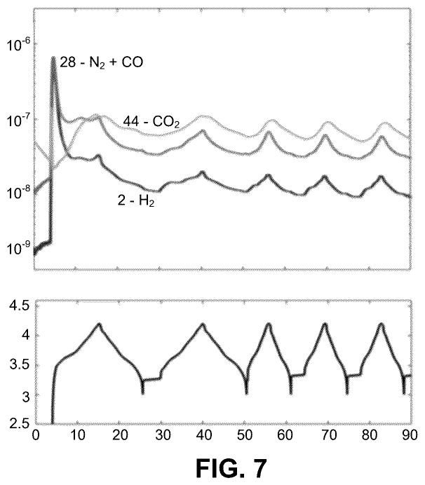

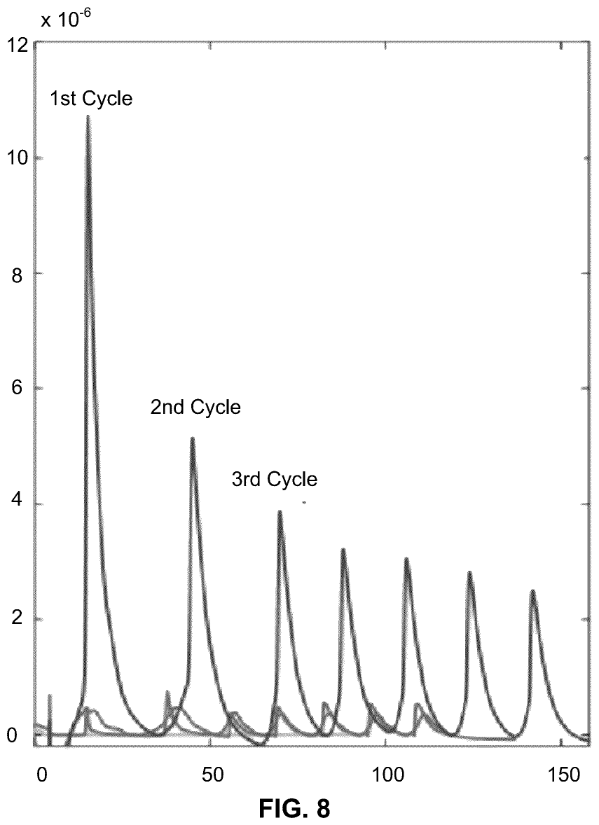

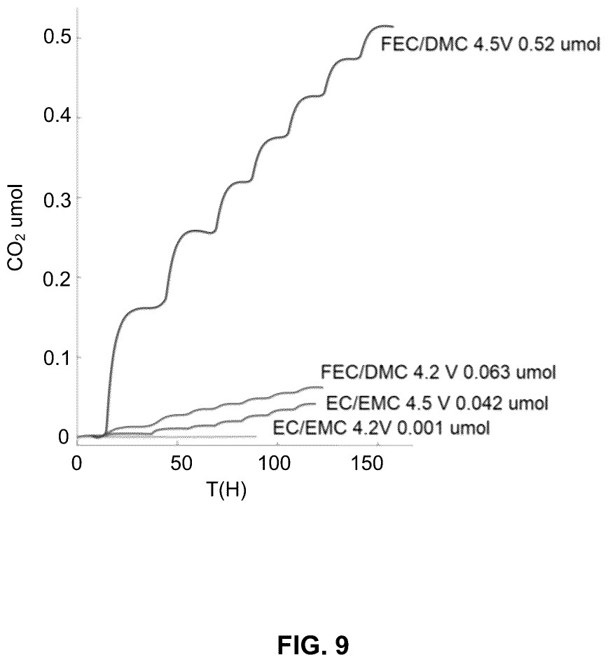

Embodiments of this disclosure provide for Differential Electrochemical Mass Spectrometry for online Gas Evolution of Pouch Cells. According to a first embodiment of this disclosure, indicated generally as 20 in FIG. 1, the method comprises at 22 supplying an inert carrier gas to a pouch cell; and at 24 supplying gas from the pouch cell to the intake of a differential electrochemical mass spectrometer to analyze the gas generated by the pouch cell. The inert carrier gas can be an inert gas, or a gas that is neither a reaction product or decomposition product of the cell, nor reactive with a reaction product or decomposition product of the cell. Depending upon the cell size, a suitable flow rate into the intake of a cell might be 0.1 sccm. The entire outflow is provided to the differential electrochemical mass spectrometer, which can have an intake on the order of about 0.012 sccm. The inert carrier gas can be argon, or some other suitable inert carrier gas. In this first embodiment, the inert carrier gas can be provided through a mass flow controller, supplied with a gas tank.

The differential electrochemical mass spectrometer may be a Hiden Analytical Mass Spectrometer Model HPR-40 DEMS, or other suitable differential electrochemical mass spectrometer. The differential electrochemical mass spectrometer provides analysis of the type and amount of gasses generated within the cell, providing an indication of the reactions within the cell.

The method of the first embodiment can facilitate the investigation of the operation of a battery cell, allowing measurement of the generation of various gases. To this end the pouch cell can be connected to a battery cycler for cycling the pouch cell through discharge and charging cycles while the gas from the pouch cell is provided to the intake of a differential electrochemical mass spectrometer, to determine the identities and quantities of the gasses generated. Similarly, the pouch cell can be heated while gas from the pouch cell is provided to the intake of a differential electrochemical mass spectrometer, to determine the identities and quantities of the gases generated at different temperatures. These gases can include oxidation products such as O₂, CO₂, CO, and reduction products of H₂, CH₄, C₂H₄, C₄H₆, and others depending upon the chemistry of the pouch cell. It can also include degradation products of the cell components. Of course, both the battery cycler and heater can be used to determine the operating of the cells under various conditions.

In operation, after establishing inlet and outlet ports in the pouch, and introducing the flow of an inert carrier gas into the inlet port in the pouch, the pouch is purged for a period of time to eliminate built-up reaction products such as N₂, O₂, CO₂, ethylene carbonate, and ethyl methyl carbonate, to achieve stable baselines before beginning experimentation and measurement.

According to an alternate version of the method indicated generally as 30 in FIG. 2, at 32, an inlet port is established in a pouch cell, and at 34, an outlet port is established in the pouch cell. At 36, a flow of an inert carrier gas into the inlet port in the pouch cell established. The inert carrier gas may be argon, or other suitable inert carrier gas. The flow rate, depending on the size and headspace of the cell, can be on the order of about 0.1 sccm. At 38, gas is received from the outlet port. At 40, the inert carrier gas allowed to purge the pouch sell of reaction products and degradation products, and thereafter, at 42, gas from the outlet is supplied to the to the inlet of a differential electrochemical mass spectrometer.

According to a second embodiment of this disclosure, a system for continuous quantitative gas evolution monitoring in a pouch cell is indicated generally as 100 in FIG. 4. The system 100 can comprise a differential mass spectrometer 102, such as a Hiden Analytical Mass Spectrometer Model HPR-40 DEMS, or other suitable differential electrochemical mass spectrometer. The system 100 can also comprise a supply of inert carrier gas, such as argon or other inert carrier gas. This supply of inert carrier gas can comprise a gas tank 104, and regulator 106 regulator for regulating the outlet pressure from the pressurized tank. A mass flow controller 114 can be provided in the first conduit 108 connecting the supply of inert carrier gas to the pouch cell 110. The system 100 further comprises a conduit 108 connected to a pouch cell 110 for conducting inert carrier gas to the pouch cell. The system 100 further comprises a conduit 112 connected to the pouch cell 110 for conducting gas from the pouch cell to the differential mass spectrometer 102.

There can be a relief outlet 116 between the regulator and the mass flow controller, to vent excess inert carrier gas. There can also be an excess flow bypass 118 in the conduit between the pouch cell and the differential mass spectrometer. Quick connectors 120 and 122 can be provided to connect and disconnect the system 100 to the pouch cell 110.

### Operation

In operation, an inlet and an outlet are connected to the head space of a cell such as pouch cell 110. The inlet and outlet of the pouch cell 110 are connected to the system 100 using the quick connectors 120 and 122. A flow of an inert carrier gas is initiated from tank 104 and regulator 106 through the mass flow controller 114 to the inlet pouch. The flow rate, depending on the size and headspace of the pouch cell 110, can be on the order of about 0.1 sccm. The gas is allowed to flow through the pouch cell, to purge the cell of accumulated reaction products and degradation products.

Once the head space has been purged, a portion of the outflow from the pouch cell can be diverted to a differential mass spectrometer 102. This allows the gases being generated in the cell to be quantified to explore what reactions are taking place in the cell. The cell can be subjected to cycling, for example using a battery cycler, and to various other conditions such as heat, with a heater, to understand the effect of the conditions on the cell performance.

What is claimed is:

1. A method for differential electrochemical mass spectrometry for online gas evolution of a pouch cell, comprising:
supplying an inert carrier gas to a pouch cell; and
supplying gas from the pouch cell to an intake of a differential electrochemical mass spectrometer.

2. The method according to claim 1 wherein the inert carrier gas is argon.

3. The method according to claim 1 wherein the inert carrier gas is supplied through a mass flow controller.

4. The method according to claim 3 wherein gas is supplied to the mass flow controller from a gas tank.

5. The method according to claim 1 wherein the pouch cell is connected to a battery cycler for cycling the pouch cell while gas from the pouch cell to the intake of a differential electrochemical mass spectrometer.

6. The method according to claim 1 wherein the pouch cell is heated while gas from the pouch cell to the intake of a differential electrochemical mass spectrometer.

7. A method for differential electrochemical mass spectrometry for online gas evolution of a pouch cell, comprising:
establishing an inlet port in the pouch;
establishing an outlet port in the pouch;
introducing a flow of an inert carrier gas into the inlet port in the pouch;
receiving gas from the outlet port;
purging the pouch with the inert carrier gas until N₂, O₂, CO₂, ethylene carbonate and ethyl methyl carbonate baselines are stable; and
thereafter supplying gas from the outlet port to an inlet of a mass spectrometer.

8. The method according to claim 7 wherein the inert carrier gas is argon.

9. The method according to claim 7 wherein the inert carrier gas is supplied through a mass flow controller.

10. The method according to claim 9 wherein gas is supplied to the mass flow controller from a gas tank.

11. The method according to claim 7 wherein the pouch cell is connected to a battery cycler for cycling the pouch cell while gas from the pouch cell to the intake of a differential electrochemical mass spectrometer.

12. The method according to claim 7 wherein the pouch cell is heated while gas from the pouch cell to the intake of a differential electrochemical mass spectrometer.

13. A system for continuous quantitative gas evolution monitoring in a pouch cell comprising:
a differential mass spectrometer;
a supply of inert carrier gas;
a conduit connected to the pouch cell for conducting inert carrier gas to the pouch cell; and
a conduit connected to the pouch cell for conducting gas from the pouch cell to an inlet of the differential mass spectrometer.

14. The system according to claim 13 further comprising a mass flow controller in the conduit connecting the supply of inert carrier gas to the pouch cell.

15. The system according to claim 14 wherein the supply of inert carrier case is a pressurized tank, and a regulator for regulating the outlet pressure from the pressurized tank.

16. The system according to claim 15 further comprising a relief outlet between the regulator and the mass flow controller.

17. The system according to claim 16 wherein the supply of inert carrier case is a pressurized tank, and a regulator for regulating the outlet pressure from the pressurized tank.

18. The system according to claim 17 further comprising an excess flow bypass in the conduit between the pouch cell and the differential mass spectrometer.

19. The system according to claim 13 wherein the supply of inert carrier case is a pressurized tank, and a regulator for regulating the outlet pressure from the pressurized tank.

20. The system according to claim 13 wherein the supply of inert carrier case is a pressurized tank, and a regulator for regulating the outlet pressure from the pressurized tank.
